(19) United States
(12) Patent Application Publication
(10) Pub. No.: US 2013/0311252 A1
(43) Pub. Date: Nov. 21, 2013

(54) Electronic display sign and merchanise pairing

(71) Applicant: Zone24x7 Inc., (US)

(72) Inventors: Llavanya Fernando, San Jose, CA (US); Schayne Jallow, San Jose, CA (US); Sankalpa Gamwarige, Colombo (LK); Ushan Karunathilaka, Karadeniya (LK); Manjula Dissanayake, Pelewatte (LK)

(73) Assignee: ZONE24X7 INC., San Jose, CA (US)

(21) Appl. No.: 13/667,204

(22) Filed: Nov. 2, 2012

Related U.S. Application Data
(63) Continuation-in-part of application No. 13/476,562, filed on May 21, 2012, now abandoned.

(51) Int. Cl. G06Q 30/02

(52) U.S. Cl. CPC G06Q 30/0241
USPC 705/14.4; 705/26.9

(57) ABSTRACT

An electronic sign includes a bi-stable display portion to display primary content such as price, type of offer, etc. and another secondary display portion to display secondary content such as enterprise name, logo, eye-catching message, etc. Enterprises are enabled to adhere to their organization's color theme while conveying secondary information. Secondary content may be fixed content or may be selected from a predefined set of content. The presently described electronic sign uses a passive medium to display secondary content along with a bi-stable display for displaying primary content, resulting in an effective, low cost solution.

### FIELD OF THE INVENTION

The present invention relates to electronic display signs.

### BACKGROUND OF THE INVENTION

Present day retail enterprises use a paper based signage system to display prices, promotional data and advertisements. Most of the existing retailers' infrastructure for sign management let the buying office or the vendor decide the price or the promotion. Store manager uses the sign management infrastructure to pull the sign content and place it in appropriate location manually. There is a system in place in the sign management infrastructure to verify the content. Present day paper based signage system is being replaced by an electronic signage system. Most of the signage appliances are portable battery operated devices and equipped with a remote connection method such as wireless communication, light modulated unidirectional communication to communicate with the back end.

Most of the electronic signs are used to display promotional data and those are placed near merchandise, which has the promotion. The same electronic sign can be used to display price or promotion of different merchandise in different locations. Therefore electronic signage is not fixed to a particular location and it can be moved from one place to another. The electronic signage system does not require manual intervention to get the update from content management server and to display it. Content update is a fully automated process. However the content displayed in the electronic sign should be associated with the particular merchandise. The particular content to be displayed is decided by the buying office of the enterprise or a product vendor who is unaware of the location of the electronic sign which is located near to the relevant merchandise in the store.

### BRIEF DESCRIPTION OF THE DRAWING FIGURES

The present invention may be further understood from the following description in conjunction with the appended drawing. In the drawing:

FIG. 1 is a diagram illustrating a manual association process.

FIG. 2A is a diagram illustrating an example of unverified content.

FIG. 2B is a diagram illustrating another example of unverified content

FIG. 3 is a diagram illustrating use of a machine readable content identifier.

FIG. 4 is a diagram illustrating a manual verification process.

FIG. 5A is a diagram illustrating an electronic sign holder.

FIG. 5B is a diagram illustrating an electronic sign mounted on the holder of FIG. 5A.

FIG. 5C is a diagram illustrating another view of the electronic sign holder of FIG. 5A.

FIG. 6 is a diagram illustrating the location identification system using existing in-store mobile application with location identification capability.

### DETAILED DESCRIPTION

### SUMMARY

The present invention addresses the methods used to associate particular merchandise to an electronic sign, and the process used to verify the content being displayed in the electronic sign.

In one aspect, a method is provided of displaying in-store promotional information about merchandise offered in a store, using one or more servers, a plurality of electronic display signs, and a network coupled between the one or more servers and the plurality of electronic display signs. The method includes: the one or more servers updating contents of an electronic display sign; and store personnel verifying updated contents of the electronic display sign using a mobile electronic device.

In another aspect, a method is provided of displaying in-store promotional information about merchandise offered in a store, using one or more servers, a plurality of electronic display signs, and a network coupled between the one or more servers and the plurality of electronic display signs. The method includes: enabling both store personnel and merchandise vendor personnel to access the one or more servers; and the one or more servers, responsive to communications from either store personnel or merchandise vendor personnel, updating contents of an electronic display sign; and store personnel verifying updated contents of the electronic display sign using a mobile electronic device.

In another aspect, pairing or verifying pairing of an electronic display sign with merchandise includes: scanning or imaging a first coded image displayed on the electronic display sign; scanning or imaging a second coded image attached to the merchandise; sending to one or more servers information derived from the first coded image and information derived from the second coded image; and at the one or more servers, pairing or verifying pairing of the electronic display sign and the merchandise.

In another aspect, pairing or verifying pairing of an electronic display sign with merchandise, using one or more servers, includes: the one or more servers controlling the electronic display sign to display a coded image; receiving at the one or more servers information derived from scanning or imaging a first coded image displayed on the electronic display sign; receiving at the one or more servers information derived from scanning or imaging a second coded image attached to the merchandise; and at the one or more servers, pairing or verifying pairing of the electronic display sign and the merchandise.

In another aspect, pairing or verifying pairing of an electronic display sign with merchandise includes: providing an electronic display sign support located nearby the merchandise with a coded identifier; attaching the electronic display sign to the electronic display sign support; the electronic display sign, as a result of being attached to the electronic display sign support, reading the coded identifier; sending from the electronic display sign to one or more servers information derived from the coded identifier; and at the one or more servers, pairing or verifying pairing of the electronic display sign and the merchandise.

In another aspect, a method of pairing or verifying pairing of an electronic display sign with merchandise, using one or more servers, includes: receiving at the one or more servers from an electronic display sign information derived a coded identifier of an electronic display sign support located nearby the merchandise upon attachment of the electronic display sign to the electronic display sign support; and at the one or more servers, pairing or verifying pairing of the electronic display sign and the merchandise.

### DESCRIPTION

### Manual Association of Sign and Merchandise

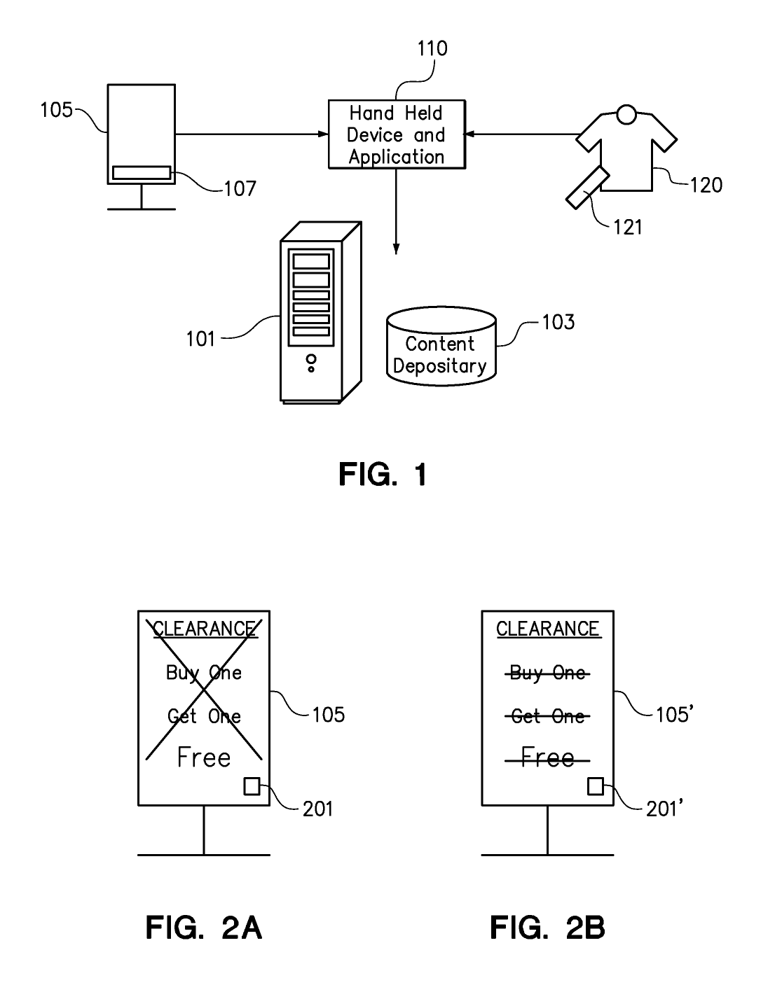

Referring to FIG. 1, a diagram is shown illustrating portions of an electronic display sign system and a manual association process in accordance with one embodiment. A content management server 101 and an associated content depository 103 are used to manage contents of electronic display signs. Every electronic sign in the store, such as an electronic display sign 105, can be uniquely identified using a unique number. The unique number may be associated with an electronic sign using a machine readable method, for example but not limited to a sticker containing a barcode 107 of the unique number or a RFID tag attached to the sign. A hand held device 110 with an application may be used to associate particular merchandise with an electronic sign. The hand held device has access to the content management server 101 through communications infrastructure which may include one or more WiFi networks, cellular networks, the Internet, etc.

FIG. 1 illustrates a manual association process. The manual association process may be a one-time process which is carried out for each specific location. This association process may be repeated each time an electronic sign is moved from one location to another. To perform manual association or pairing, the store associate scans the unique identifier 107 of the electronic sign 105 and a relevant machine readable code 121 (such as Universal Product Code) of merchandise 120 using the hand held device 110. The hand held device 110 and the application will communicate with the content management server 101 and request the content management server to register the electronic sign 105 with the relevant merchandise 120. The content management server 101 then uses this relationship to push content for the merchandise 120 to the associated electronic sign 105.

### Manual Verification Method

Content of each electronic sign 105 is pushed from a content management server 101. In one embodiment, the electronic sign 105 treats any new content as “unverified” content. The electronic sign 105 visually indicates the unverified state, although it shows the updated content. For example, indicating a cross along the diagonal (FIG. 2A) is a visual indication of unverified content. FIG. 2B illustrates another display showing an example of unverified content.

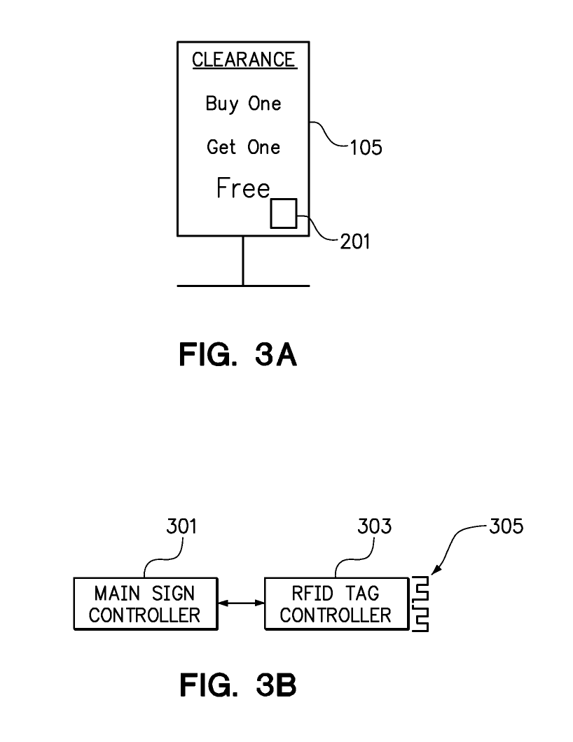

The content of each display screen may be given a content ID (201, 201′). The content ID may be made available in machine readable format, for example but not limited to, a barcode displayed along with the content, or RFID tag which is programmed by internal circuitry and firmware of the electronic sign. FIG. 3A illustrates one example of a machine readable content identifier 201 (barcode). FIG. 3B illustrates another example of a machine readable content identifier 201′ (RFID tag). A main sign controller 301 communicates with the RFID tag, which consists of RFID controller 303 and RFID antenna 305, to program the relevant content ID.

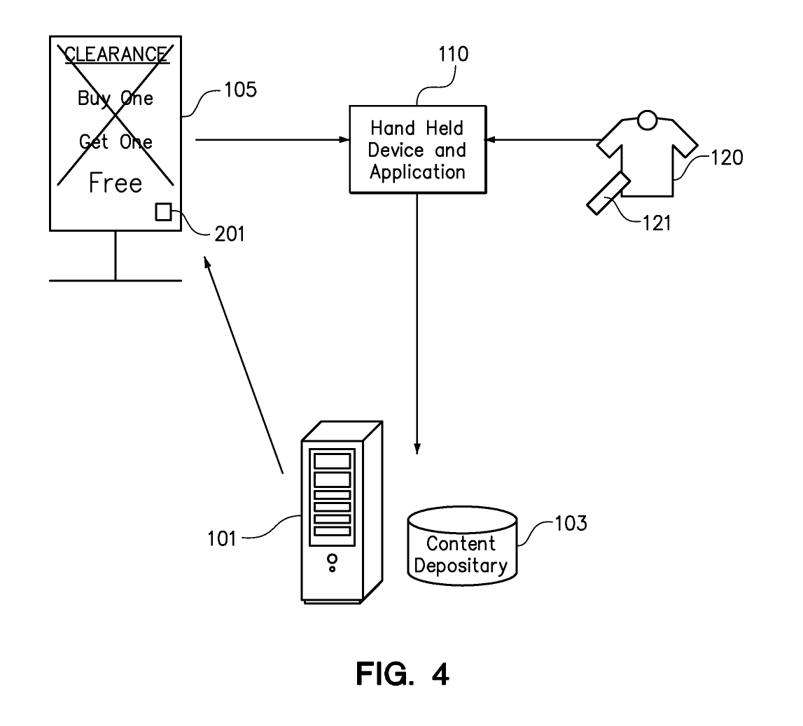

FIG. 4 illustrates a manual verification process. To verify content, the store associate scans the merchandise 120 and the content ID 201/201′ using the handheld device 110 and the application. The content management server 101 then verifies the request and sends a “Verified” message to the electronic sign 105. The electronic sign 105 will delete the “unverified” indication and show the appropriate sign content.

### Automated Association and Verification

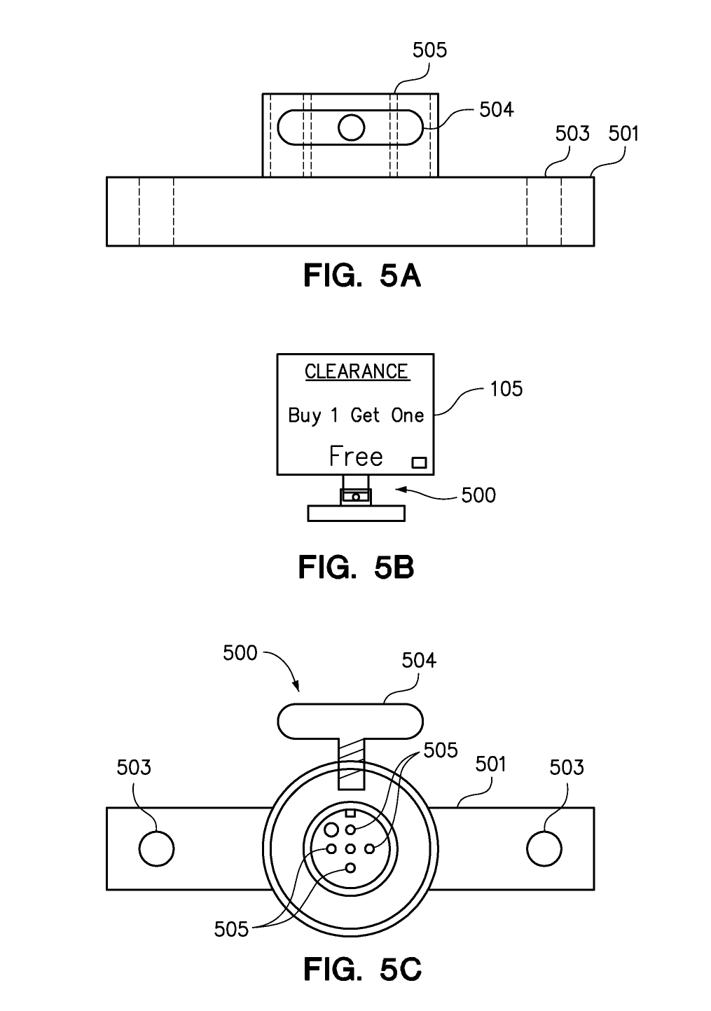

An electronic sign place holder, installed in a fixed location, may be used to automate the association and verification process. As shown in FIGS. 5A and 5B, in one embodiment, the placeholder 500 comprises a mechanical structure 501 including mounting holes 503 and a screw fastener 504 to hold the electronic sign, an electronic unique identifier (not shown) and electrical connections 505 to access the content of the electronic unique identifier. The electronic unique identifier can be programmed in a semiconductor read only memory type device, smart card type device, any electronic media that can store and access unique number, or printed circuit board traces, etc. Referring to FIG. 5B, when a sign 105 is placed in an electronic sign place holder 500, it reads the unique ID from the provided electrical interface 505 and sends it along with a unique identifier of the electronic sign 105 itself to the content management server 101. The content management server 101 associates the electronic sign 105 and the correct merchandise by retrieving the set of data for merchandise which is located near the location given by the place holder identifier. If there are any updates to merchandise, the content management server 101 finds the particular identifier of the electronic sign 105 and sends the update to the relevant electronic sign 105.

### Automated Pairing

In other embodiments, pairing between electronic signs and merchandise display information may be achieved automatically. For example, electronic signs located sufficiently close to particular merchandise may be automatically paired with that merchandise. In some instances, location information of merchandise and/or electronic signs may be known within a content management system. In other instances, location information of merchandise and/or electronic signs may be determined or augmented empirically.

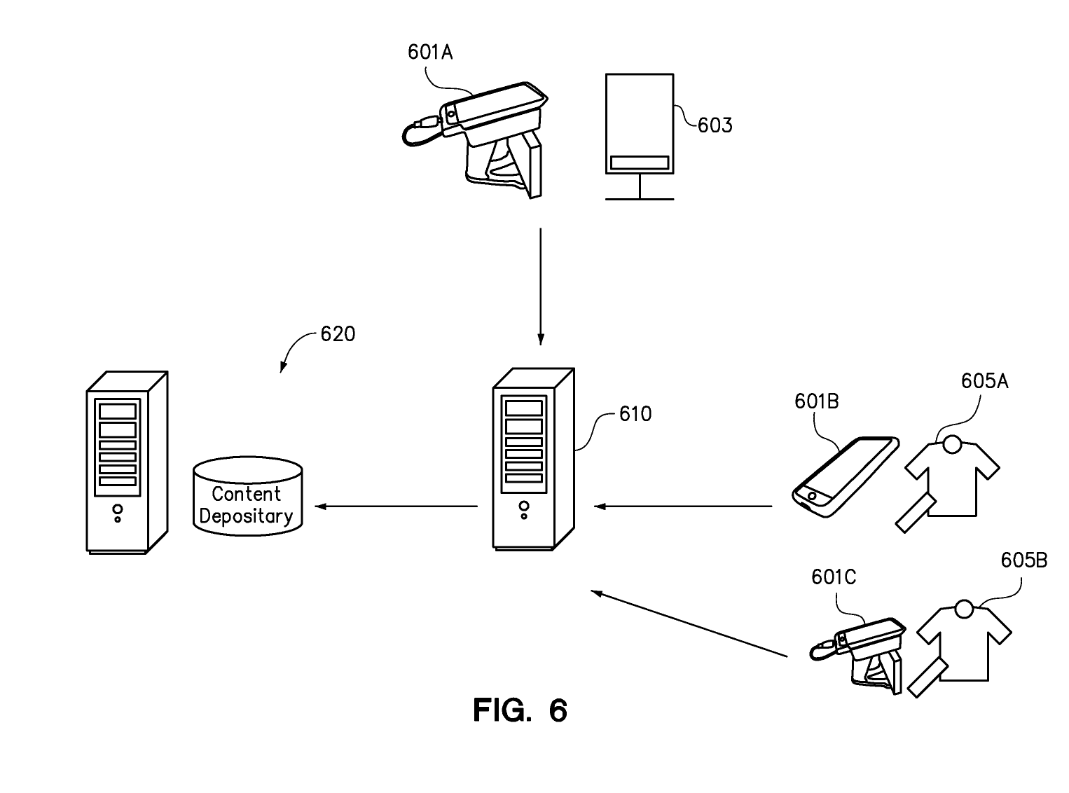

An example of a system in which location information of merchandise and/or electronic signs may be determined or augmented empirically is shown in FIG. 6. Location-aware devices 601A, 601B, 6010, etc., are used to interact with electronic signs 603 and/or merchandise 605A, 605B, etc. During the course of such interaction, location information regarding the electronic signs and/or merchandise is gathered and conveyed to a content management server, for example via a location calculation server 610. The content management server 620 may then use the resulting location information to perform automatic pairing of electronic signs and merchandise display information as described.

More particularly, the content management server 620 may not know the exact location information of the merchandize due to existing processes of the retail store, which may not support recording the location information of the merchandize. However most retailers offer specific mobile application for customers to check the price and view further information and reviews by scanning the item. Similarly store associates use mobile applications inside the store for various tasks such as taking down stocks. In the present embodiment, the mobile applications running on the mobile devices 601 are configured such that indoor localization services are used by the mobile application and such that the mobile application determines the location of an item when the item is scanned by the mobile application. Then the mobile application sends the item code and location information to the location calculation server 610. The location calculation server 610 calculates the location information of that merchandise, using statistical methods as needed depending on the quality of the location information. The location calculation server 610 may further map location information to aisle location before sending the location information to the content management server 620 along with the merchandise code.

In the present embodiment, location-aware placeholders such as placeholder 500 of FIG. 5 are not required. If a placeholder 500 is not available for a particular sign, the store associate's mobile application can be used to identify the location by scanning the unique identifier of the sign and indoor location services are then used to determine the location of the sign.

In other embodiments, the electronic signs themselves (which are network connected) may be equipped with dedicated location hardware, for example but not limited to compass, location engine chips, etc., which is capable of finding exact indoor location or providing raw data used to calculate relative or exact position. A placeholder like that of placeholder 500 is not required for this type of sign.

It will be apparent to those skilled in the part that the present invention can be embodied in different forms without departing from the spirit or essential character thereof. The disclosed embodiments are therefore intended in all respects to be illustrative and not restrictive. The scope of the invention is defined by the appended claims, not the foregoing description, and all changes which come within the range of equivalents thereof are intended to be embraced therein. Words of approximation, except as otherwise noted, are used herein to mean plus or minus twenty percent of nominal value.

What is claimed is:

1. A method of pairing or verifying pairing of an electronic display sign with merchandise, comprising:
reading a first identifier of the electronic display sign;
reading a second identifier attached to the merchandise;
sending to one or more servers information derived from the first identifier and information derived from the second identifier; and
at the one or more servers, pairing or verifying pairing of the electronic display sign and the merchandise.

2. The method of claim 1, comprising controlling the electronic display sign to display information relating to the merchandise.

3. The method of claim 1, comprising, prior to reading the first identifier, updating display content of the electronic display sign in accordance with a prior pairing;
displaying on the electronic display sign an indication that updated display contents of the electronic display sign remain tentative;
verifying pairing of the electronic display sign and the merchandise; and
removing the indication that the updated display contents are tentative.

4. A method of pairing or verifying pairing of an electronic display sign with merchandise, using one or more servers, comprising:
the one or more servers controlling the electronic display sign to display a coded image;
receiving at the one or more servers information derived from scanning or imaging a first coded image displayed on the electronic display sign;
receiving at the one or more servers information derived from scanning or imaging a second coded image attached to the merchandise; and
at the one or more servers, pairing or verifying pairing of the electronic display sign and the merchandise.

5. The method of claim 4, comprising the one or more servers controlling the electronic display sign to display information relating to the merchandise.

6. The method of claim 4, comprising:
the one or more servers, prior to receiving at the one or more servers information derived from scanning or imaging the first coded image, updating display content of the electronic display sign in accordance with a prior pairing;
the one or more servers causing to be displayed on the electronic display sign an indication that updated display contents of the electronic display sign remain tentative;
the one or more servers verifying pairing of the electronic display sign and the merchandise; and
the one or more servers causing to be removed the indication that the updated display contents are tentative.

7. A method of pairing or verifying pairing of an electronic display sign with merchandise, comprising:
providing an electronic display sign support located nearby the merchandise with a coded identifier;
attaching the electronic display sign to the electronic display sign support;
the electronic display sign, as a result of being attached to the electronic display sign support, reading the coded identifier;
sending from the electronic display sign to one or more servers information derived from the coded identifier; and
at the one or more servers, pairing or verifying pairing of the electronic display sign and the merchandise.

8. The method of claim 7, wherein the coded identifier is hard-coded as part of the electronic display sign support.

9. The method of claim 7, wherein the coded identifier is stored on a removable medium.

10. The method of claim 7, comprising controlling the electronic display sign to display information relating to the merchandise.

11. A method of pairing or verifying pairing of an electronic display sign with merchandise, using one or more servers, comprising:
receiving at the one or more servers from an electronic display sign information derived from a coded identifier of an electronic display sign support located nearby the merchandise upon attachment of the electronic display sign to the electronic display sign support; and
at the one or more servers, pairing or verifying pairing of the electronic display sign and the merchandise.

12. The method of claim 11, comprising the one or more servers controlling the electronic display sign to display information relating to the merchandise.

13. A method of displaying in-store promotional information about merchandise offered in a store, using one or more servers, a plurality of electronic display signs, and a network coupled between the one or more servers and the plurality of electronic display signs, comprising:
the one or more servers updating contents of an electronic display sign; and
store personnel verifying updated contents of the electronic display sign using a mobile electronic device.

14. The method of claim 13, comprising, prior to verifying, displaying on the electronic display sign an indication that the updated display contents are unverified.

15. The method of claim 14, wherein verifying comprises reading both an identifier of the electronic display sign and an identifier attached to the merchandise.

16. A method of displaying in-store promotional information about merchandise offered in a store, using one or more servers, a plurality of electronic display signs, and a network coupled between the one or more servers and the plurality of electronic display signs, comprising:
enabling both store personnel and merchandise vendor personnel to access the one or more servers; and
the one or more servers, responsive to communications from either store personnel or merchandise vendor personnel, updating contents of an electronic display sign.
store personnel verifying updated contents of the electronic display sign using a mobile electronic device.

17. The method of claim 16, comprising store personnel verifying updated contents of the electronic display sign using a mobile electronic device.

18. The method of claim 15, wherein verifying comprises reading both an identifier of the electronic display sign and an identifier attached to the merchandise.

19. A method of pairing or verifying pairing of an electronic display sign with merchandise, the electronic display sign comprising a hardware module for determining location specific information, the method comprising:
the electronic display sign sending location specific information to a backend system,
said backend system calculating location of the electronic display sign and mapping its possible aisle location,
said backend system further pairing the electronic display sign and merchandise located nearby the sign.

20. A system comprising:
a mobile application used by a customer to scan merchandise bearing an item code, said application being configured to send location information of a location where said scanning was performed; and
a backend system for receiving the location information and the item code, said backend system being configured to associate the location information and the item;
wherein said backend system calculates a location of the merchandise and maps the location to an aisle location;
wherein said back end system pairs and verifies pairing of merchandise and an electronic display sign located nearby the merchandise using the aisle location.

21. A system comprising:
a mobile application used by a store associate to scan a code of an electronic display sign or content displayed in the electronic display sign, said application being configured to send location information of a location where said scanning was performed;
and
a backend system for receiving the location information and said code of the electronic display sign or content, said back end system being configured to associate the location information and the electronic display sign;
wherein said backend system calculates a location of the merchandise and maps the location to a possible location of an electronic display sign;
wherein said back end system pairs and verifies the pairing of merchandise and an electronic display sign located nearby the merchandise.
